(19) United States
(12) Patent Application Publication
(10) Pub. No.: US 2026/0276914 A1
(43) Pub. Date: Sep. 17, 2026

(54) OPTOELECTRONIC SEMICONDUCTOR UNIT AS WELL AS COMPONENTS AND A PRODUCTION METHOD THEREOF

(71) Applicant: ams-OSRAM International GmbH, Regensburg (DE)

(72) Inventors: Farhang GHASEMI AFSHAR, Wenzenbach (DE); Christian SCHOERNER, Regensburg (DE)

(73) Assignee: ams-OSRAM International GmbH, Regensburg (DE)

(21) Appl. No.: 19/166,976

(22) PCT Filed: Mar. 7, 2024
(86) PCT No.: PCT/EP2024/055966

§ 371 Date: Sep. 19, 2025

(30) Foreign Application Priority Data
Mar. 22, 2023 (DE) 10 2023 107 135.1

(51) Int. Cl. G02B 6/42

(52) U.S. Cl. CPC G02B 6/423; G02B 6/4202; G02B 6/424; G02B 6/4245; G02B 6/4296; G02B 6/4268; G02B 6/4274

(57) ABSTRACT

An optoelectronic semiconductor unit is specified including at least one optoelectronic device and at least one optoelectronic semiconductor component, wherein the optoelectronic semiconductor component is arranged on a mounting area of a substrate of the optoelectronic device, and alignment portions of the optoelectronic semiconductor component and positioning portions of the optoelectronic device engage with one another, wherein a width difference between every positioning portion and its related alignment portion becomes smaller in a longitudinal direction towards a functional unit of the optoelectronic device. Moreover, a method for producing an optoelectronic semiconductor unit is specified.

### CROSS-REFERENCE TO RELATED APPLICATIONS

The present application is a national stage entry from International Application No. PCT/EP2024/055966, filed on Mar. 24, 2024, published as International Publication No. WO 2024/194025 A1 on Sep. 26, 2024, and claims priority to German Patent Application No. 10 2023 107 135.1, filed Mar. 22, 2023, the disclosures of all of which are hereby incorporated by reference in their entireties.

### FIELD

An optoelectronic semiconductor unit, which may be a photonic integrated circuit (so-called PIC) unit, is specified. In the context of the present application, the term “semiconductor” may denote including a semiconductor material.

Moreover, components of the optoelectronic semiconductor unit including an optoelectronic, for example radiation-emitting semiconductor component and an optoelectronic device including, for example, a waveguide are specified. In the context of the present application, the components, which may be parts of the optoelectronic semiconductor unit, are denoted as “optoelectronic” components, which means that they are suitable for an optoelectronic unit and may, but do not necessarily have to provide for an electronic and/or optical function.

Furthermore, a method for producing an optoelectronic semiconductor unit is specified. The method comprises an alignment of the components of the optoelectronic semiconductor unit.

### BACKGROUND

Publication document U.S. Pat. No. 9,606,308 B2, for example, describes techniques for flip-chip assembly and packaging of microelectronic, photonic and optoelectronic devices in which three-dimensional alignment of package components is achieved using solder surface tension during a solder reflow process to move one or more package components and align such components in x, y and z directions using mechanical stops and chip butting techniques. However, this alignment process works only with a soldering method and solder material in its liquid phase, which is critical to alignment reliability.

One object inter alia is to specify an optoelectronic semiconductor unit having improved alignment reliability and to specify components of the optoelectronic semiconductor unit providing for improved alignment reliability. This object is achieved inter alia by the optoelectronic semiconductor unit, the optoelectronic semiconductor component, and the optoelectronic device according to the independent claim. Further embodiments and further developments of the optoelectronic semiconductor unit, the optoelectronic semiconductor component and the optoelectronic device are the subject-matter of the dependent claims.

It is a further object inter alia to specify a method for producing an optoelectronic semiconductor unit allowing for improved alignment reliability. This object is achieved inter alia by the method according to the independent claim.

Further embodiments and further developments of the method are the subject-matter of the dependent claims.

### SUMMARY

According to at least one embodiment of an optoelectronic semiconductor component, it comprises a substrate including alignment portions on a mounting side, wherein the alignment portions have in each case a main extension along a longitudinal direction. A “main extension” may designate in the context of the present application an extension which is greater than at least one other extension of an element. The alignment portions may be parallel to each other within common production tolerances. In the context of the present application, “common production tolerances” may denote deviations of at most ±10%.

Moreover, the optoelectronic semiconductor component may comprise a semiconductor layer stack arranged on the substrate. Especially, the semiconductor layer stack is arranged on the mounting side of the substrate in an interspace between the alignment portions. For example, the semiconductor layer stack is epitaxially grown on the substrate.

According to at least one embodiment or configuration, a width of the alignment portions determined along a lateral direction perpendicular to the longitudinal direction in each case is constant within common production tolerances. In other words, it is possible that the width of the alignment portions does not change essentially along the longitudinal direction. In the context of the present application, “along” or “in” one direction includes parallel and antiparallel orientations with respect to this direction. The alignment portions may serve for a lateral alignment of the optoelectronic semiconductor component relative to another component.

According to at least one embodiment or configuration, the alignment portions are depressions of the substrate. For example, the depressions have a cuboid shape and thus a rectangular cross section perpendicular to both the lateral and longitudinal direction.

According to at least one embodiment or configuration, the width of the alignment portions in each case may have values ranging from 40 μm to 60 μm, wherein deviations of ±10% are possible. Moreover, a vertical extension or depth of the alignment portions determined along a vertical direction perpendicular to the longitudinal and lateral directions may range in each case from 20 μm to 30 μm, wherein deviations of ±10% are possible.

According to at least one embodiment or configuration, the semiconductor layer stack comprises a first semiconductor region of a first conductivity type, for example an n-doped semiconductor region, on a side facing the substrate, a second semiconductor region of a second conductivity type, for example a p-doped semiconductor region, on a side facing away from the substrate and an active region arranged between the first semiconductor region and the second semiconductor region, wherein the active region is provided for emitting radiation. It is also possible that the first semiconductor region is p-doped, while the second semiconductor region is n-doped.

The active region may comprise a sequence of single layers which form a quantum well structure, in particular a single quantum well (SQW) structure or multiple quantum well (MQW) structure. Moreover, the first and second semiconductor regions may each have a sequence of single layers, some of which may be undoped or lightly doped.

Materials based on arsenide, phosphide or nitride compound semiconductors, for example, are suitable for the semiconductor regions or single layers of the semiconductor layer stack. “Based on arsenide, phosphide or nitride compound semiconductors” means in the present context that the semiconductor layers contain AlₙGaₘIn₁₋ₙ₋ₘAs, AlₙGaₘIn₁₋ₙ₋ₘP, InₙGa₁₋ₙAsₘP₁₋ₘ or AlₙGaₘIn₋ₙ₋ₘN, where 0≤n≤1, 0≤m≤1 and n+m≤1. This material does not necessarily have to have a mathematically exact composition according to the above formula. Rather, it may have one or more dopants as well as additional constituents that do not substantially change the characteristic physical properties of the AlₙGaₘIn₁₋ₙ₋ₘAs, AlₙGaₘIn₁₋ₙ₋ₘP, InₙGa₁₋ₙAsₘP₁₋ₘ or AlₙGaₘIn₁₋ₙ₋ₘN material. For simplicity, however, the above formula includes only the essential constituents of the crystal lattice (Al, Ga, In, As or P or N, respectively), even though these may be partially replaced by small amounts of other substances. A quinternary semiconductor consisting of Al, Ga, In (group III) and P and As (group V) is also conceivable.

According to at least one embodiment or configuration, the optoelectronic semiconductor component is a laser component, which is suitable for emitting laser radiation having a wavelength for example in the spectral range between ultraviolet and infrared.

According to at least one embodiment or configuration, the optoelectronic semiconductor component is an edge emitting laser component. In this embodiment or configuration, the semiconductor layer stack may comprise a radiation exit surface, which is arranged at a side face of the optoelectronic semiconductor component, for example perpendicularly to the longitudinal direction, and where a major part of the laser radiation may exit the optoelectronic semiconductor component.

According to at least one embodiment or configuration, the optoelectronic semiconductor component embodied as an edge emitting laser component comprises a ridge structure, wherein the ridge structure extends between the alignment portions. The ridge structure may be a part of the semiconductor layer stack produced by patterning the semiconductor layer stack on a side of the second semiconductor region facing away from the substrate.

The patterning process may be an etching process. As the etching process can stop precisely on the second semiconductor region, the ridge structure has a reliable vertical extension and thus provides for a constant vertical spacing to the radiation exit surface with low tolerances. Therefore, a main surface of the ridge structure facing away from the substrate may be used for a vertical alignment of the optoelectronic semiconductor component relative to another component.

According to at least one embodiment of an optoelectronic device, it comprises a substrate including a mounting area for mounting an optoelectronic semiconductor component having alignment portions. In particular, the optoelectronic semiconductor component that may be mounted on the mounting area is a component of the type described above and thus may have all the features described above. For example, the substrate of the optoelectronic device comprises or consists of a semiconductor material like silicon. Hence, the optoelectronic device may be an optoelectronic semiconductor device.

According to at least one embodiment or configuration, the optoelectronic device comprises a functional unit, which provides for an optical function like a waveguide function, for example. In other words, the functional unit may be a waveguide. The functional unit may be arranged on the substrate. Moreover, the functional unit may be arranged at least partly adjacent to the mounting area. In other words, the functional unit and the mounting area may be arranged in such a way that they overlap at most partially in a longitudinal direction. Furthermore, the functional unit may have an end face intended to face the optoelectronic semiconductor component. For example, the end face is a radiation entrance surface facing the radiation exit surface of the optoelectronic semiconductor component.

According to at least one embodiment or configuration, the functional unit embodied as a waveguide comprises layers of different refractive indices. For example, the waveguide may comprise an upper and a lower cladding layer and a core layer sandwiched between the upper and lower cladding layers, wherein the upper and lower cladding layers have a lower refractive index than the core layer. Suitable materials are, for example, silicon nitride for the core layer and silicon dioxide for the upper and lower cladding layers. It is also possible that the functional unit comprises or consists of a semiconductor material. Hence, the optoelectronic device may be an optoelectronic semiconductor device.

According to at least one embodiment or configuration, the optoelectronic device comprises a positioning structure. Especially, the positioning structure is suitable for an alignment of the optoelectronic semiconductor component relative to the optoelectronic device, in particular relative to the functional unit in three spatial directions including a longitudinal, lateral and vertical direction, which are all perpendicular to each other.

According to at least one embodiment or configuration, the positioning structure comprises positioning portions, which are arranged at the mounting area and are provided for an assembly with the alignment portions of the optoelectronic semiconductor component. The positioning portions may have in each case a main extension along the longitudinal direction. The positioning portions may be parallel to each other within common production tolerances. Moreover, the positioning portions may begin on the mounting area and finish at the end face of the functional unit.

A width of the positioning portions determined along a lateral direction perpendicular to the longitudinal direction in each case may increase along the longitudinal direction towards the functional unit. In other words, the positioning portions may have a broadening shape in the longitudinal direction.

According to at least one embodiment or configuration, the positioning portions are rod-like elements protruding from the mounting area.

According to at least one embodiment or configuration, the width of the positioning portions on a side facing away from the functional unit in each case may have values ranging from 10 μm to 20 μm, wherein deviations of ±10% are possible. Furthermore, the width of the positioning portions on a side facing the functional unit in each case may have values ranging from 40 μm to 60 μm, wherein deviations of ±10% are possible. Moreover, a vertical extension or height of the positioning portions determined along the vertical direction may range in each case from 15 μm to 25 μm, wherein deviations of ±10% are possible.

The positioning portions having a smaller width on a side facing away from the functional unit can provide in each case for a larger gap when the alignment portions are placed on the smaller ends of the positioning portions. The larger gap has the advantage that standard precision pick and place tools providing for high speed but having a reduced accuracy in the single to double digit micrometer range, for example, can be used for placing the optoelectronic semiconductor component on the mounting area, while the smaller gap at the larger ends of the positioning portions provides for an alignment of higher accuracy. This is advantageous, for example, in cases where the optoelectronic semiconductor component is embodied as an edge emitting laser, which requires a high-precision alignment of the radiation exit surface relative to the radiation entrance surface of the functional unit embodied as a waveguide so that radiation coming from the optoelectronic semiconductor component can be effectively coupled into the functional unit or waveguide.

According to at least one embodiment or configuration, the positioning structure comprises vertical adjustment regions arranged at the mounting area and adjacent to the positioning portions, wherein the vertical adjustment regions are provided for a vertical adjustment of the optoelectronic semiconductor component relative to the functional unit.

For example, the vertical adjustment regions are arranged on sides of the positioning portions facing each other. The vertical adjustment regions may be arranged in such a way that regions of the semiconductor layer stack arranged between the alignment portions and the ridge structure are positioned on the vertical adjustment regions when the optoelectronic semiconductor component is mounted on the mounting area.

Precisely knowing a vertical position of the radiation exit surface due to the ridge structure having a reliable vertical extension, a vertical extension of the vertical adjustment regions can be adjusted in such a way that the radiation exit surface is placed in the right position opposite to the end face of the functional unit, for example in a position where the radiation is precisely coupled into the core layer of the waveguide. Especially, the vertical adjustment regions have a vertical extension, which in each case may be at least as large as the vertical extension of the ridge structure. Possible values of the vertical extension of the vertical adjustment regions range in each case from 1 μm to 5 μm, wherein deviations of ±10% are possible.

According to at least one embodiment or configuration, the positioning structure comprises projecting portions projecting beyond the end face of the functional unit. The projecting portions may be structured portions of the functional unit. For example, a distance between the projecting portions and the end face of the functional unit along the longitudinal direction in each case does not exceed a value of 5 μm, especially does not exceed a value of 1 μm, wherein deviations of ±10% are possible. The projecting portions may serve as mechanical stoppers providing for a distance between the optoelectronic semiconductor component and the functional unit along the longitudinal direction. This is advantageous if the radiation exit surface has a dielectric, for example an optical coating, which can be protected from damage if it does not get into contact with the end face of the functional unit. The projecting portions can be arranged on sides of the positioning portions facing away from each other.

According to at least one embodiment or configuration, the positioning structure is formed from the same material as the upper and/or lower cladding layer(s) of the waveguide. For example, the positioning structure contains or consists of silicon dioxide.

According to at least one embodiment or configuration of an optoelectronic semiconductor unit, it comprises at least one optoelectronic device of the kind mentioned above, which thus may have all the features described above.

For example, the optoelectronic device of the optoelectronic semiconductor unit includes:
a substrate comprising a mounting area for mounting an optoelectronic semiconductor component having alignment portions,
a functional unit, which
   provides for an optical function,
   is arranged at least partly adjacent to the mounting area, and
   has an end face intended to face the optoelectronic semiconductor component,
a positioning structure comprising positioning portions, which are arranged at the mounting area and are provided for an assembly with the alignment portions of the optoelectronic semiconductor component, wherein the positioning portions have in each case a main extension along a longitudinal direction, and wherein
   a width of the positioning portions determined along a lateral direction perpendicular to the longitudinal direction in each case increases along the longitudinal direction towards the functional unit.

Moreover, the optoelectronic semiconductor unit may comprise at least one optoelectronic semiconductor component of the kind mentioned above, which thus may have all the features described above. For example the optoelectronic semiconductor component of the optoelectronic semiconductor unit includes:
a substrate comprising alignment portions on a mounting side, wherein the alignment portions have in each case a main extension along a longitudinal direction, and
a semiconductor layer stack, which is arranged on the mounting side of the substrate in an interspace between the alignment portions.

According to at least one embodiment or configuration of the optoelectronic semiconductor unit, the optoelectronic semiconductor component is arranged on the mounting area of the substrate of the optoelectronic device, and the alignment portions and positioning portions engage with one another, wherein a width difference between every positioning portion and its related alignment portion becomes smaller in the longitudinal direction towards the functional unit. As mentioned above, the larger gap on a side facing away from the functional unit has the advantage that standard precision pick and place tools providing for high speed may be used when placing the optoelectronic semiconductor component on the optoelectronic device, while the smaller gap provides for a lateral alignment of high accuracy.

The optoelectronic semiconductor unit may be a photonic integrated circuit (so-called PIC) unit, wherein the optoelectronic semiconductor component embodied as an edge emitting laser component and the optoelectronic device comprising a waveguide represent photonic components forming a functioning circuit.

According to at least one embodiment or configuration, the width of the positioning portions decreases more and more compared to the width of the related alignment portions with increasing distance to the functional unit in the longitudinal direction.

According to at least one embodiment or configuration, vertical distances of the alignment portions and positioning portions may be kept constant. For example, a vertical extension of every positioning portion is smaller than a vertical extension of its related alignment portion. This lowers surface friction between the optoelectronic semiconductor component and the optoelectronic device when moving the optoelectronic semiconductor component to its final position on the optoelectronic device.

According to at least one embodiment or configuration, the substrate of the optoelectronic device comprises a cavity below the semiconductor layer stack of the optoelectronic semiconductor component, wherein a contact material is arranged in the cavity for electrically and/or thermally contacting the semiconductor layer stack. For example, the optoelectronic semiconductor component comprises a contact layer arranged at the second semiconductor region, which is electrically and/or thermally contacted by the contact material.

According to at least one embodiment or configuration, the contact material is a sintered material. Compared to a liquid solder material, the risk of contamination of the semiconductor layer stack of the optoelectronic semiconductor component is lower with the sintered material. However, it is also possible that the contact material is a solder material which is provided as a solder paste and thermally cured afterwards. Advantageously, in contrast to the alignment process of the prior art described above using solder surface tension, the contact material can be selected freely.

According to at least one embodiment or configuration, the substrate of the optoelectronic device comprises at least one recess below the substrate of the optoelectronic semiconductor component, wherein an adhesive material is arranged in the at least one recess, attaching the optoelectronic semiconductor component to the optoelectronic device. For example, the adhesive material is a glue material containing or consisting of a plastic material.

According to at least one embodiment or configuration of a method, the method is provided for producing an optoelectronic semiconductor unit of the kind mentioned above, which thus may have all the features described above. The method may comprise the following steps, preferably in the cited order:
providing at least one optoelectronic device of the kind mentioned above,
providing at least one optoelectronic semiconductor component of the kind mentioned above,
placing the at least one optoelectronic semiconductor component on the mounting area of the substrate of the at least one optoelectronic device at a distance to the functional unit in the longitudinal direction in such a way that the alignment portions and positioning portions engage with each other, and
moving the at least one optoelectronic semiconductor component towards the functional unit to a final position by decreasing the distance, wherein at the final position a width difference between every positioning portion and its related alignment portion becomes smaller in the longitudinal direction towards the functional unit.

The alignment portions and positioning portions engaging with each other and also the other possible features of the positioning structure like the vertical alignment portions and the projecting portions allow for a passive alignment of the at least one optoelectronic device and the at least one optoelectronic semiconductor component with high accuracy.

A pick and place tool may put the at least one optoelectronic semiconductor component at a predefined initial position on the at least one optoelectronic device where the width of the positioning portions is smaller than the width of the alignment portions. This ensures the catch-up of the positioning portions and alignment portions with the limited precision of a passive pick and place tool. The positioning portions may serve as guide bars where the optoelectronic semiconductor component glides along to its final position. The optoelectronic semiconductor component can be laterally fixed in the final position as the width of the positioning portions in each case approximates the width of the alignment portions.

According to at least one embodiment or configuration, a plurality of optoelectronic devices is provided as a composite, wherein at least the substrate is a common element.

Moreover, a plurality of optoelectronic semiconductor components may be provided as a composite with a common substrate and a plurality of semiconductor layer stacks provided thereon. For example, the plurality of optoelectronic semiconductor components may be provided as at least one laser bar.

Advantageously, the whole process can be carried out at wafer level with no need for an active alignment process.

According to at least one embodiment or configuration, the at least one optoelectronic semiconductor component is moved by reducing an air pressure in a gap between the optoelectronic semiconductor component and the functional unit.

For example, the optoelectronic device is provided with a canal structure on top of the functional unit, wherein the canal structure has a first open side facing the at least one optoelectronic semiconductor component and a second open side facing away from the functional unit, and the air pressure is reduced by air suction at the second open side. In other words, a vacuum may be applied on top of the functional unit, which results in a low pressure zone in the gap between the optoelectronic semiconductor component and the functional unit at a distance larger than zero. Thus, the optoelectronic semiconductor component is pulled towards the functional unit. Advantageously, the optoelectronic semiconductor component can be stopped by the projecting portions of the positioning structure such that the optoelectronic semiconductor component is at a distance to the end face of the functional unit.

According to at least one embodiment or configuration, the substrate of the optoelectronic device is provided with at least one through hole below the substrate of the optoelectronic semiconductor component, and an air pressure is reduced by air suction at the at least one through hole to vertically align the optoelectronic semiconductor component with the optoelectronic device. During the movement of the optoelectronic semiconductor component, however, the air pressure may be increased at the at least one through hole, which helps to overcome potential frictions between the optoelectronic semiconductor component and the vertical adjustment regions of the optoelectronic device.

The optoelectronic semiconductor component, device and unit are suitable for 3D imaging, LIDAR, AR (augmented reality) or VR (virtual reality) applications and for/as photonic integrated circuits.

Further preferred embodiments and further developments of the optoelectronic semiconductor component, device and unit and the method for producing an optoelectronic semiconductor unit will become apparent from the exemplary embodiments explained below in conjunction with FIGS. 1 to 4.

### BRIEF DESCRIPTION OF THE DRAWINGS

FIG. 1A shows a schematic perspective view and FIG. 1B a schematic view of a cross-section along plane AA′ (see FIG. 1A) of an exemplary embodiment of an optoelectronic semiconductor component, and FIGS. 1C and 1D show in each case enlarged sections of the schematic cross-sectional view of FIG. 1B,

FIG. 2A shows a schematic perspective view and FIG. 2C a schematic plan view of an exemplary embodiment of an optoelectronic device, and FIG. 2B shows an enlarged section of the schematic perspective view of FIG. 2A and FIGS. 2D and 2E enlarged sections of the schematic plan view of FIG. 2C,

FIG. 3A shows a schematic perspective view of an exemplary embodiment of an optoelectronic semiconductor unit, and FIGS. 3B and 3C show enlarged sections of the schematic perspective view of FIG. 3A,

FIGS. 4A to 4c illustrate different steps of an exemplary embodiment of a method for producing an optoelectronic semiconductor unit.

### DETAILED DESCRIPTION

Identical, equivalent or equivalently acting elements may be indicated with the same reference numerals in the figures. The figures are schematic illustrations and thus not necessarily true to scale. Comparatively small elements and particularly layer thicknesses can rather be illustrated exaggeratedly large for the purpose of better clarification.

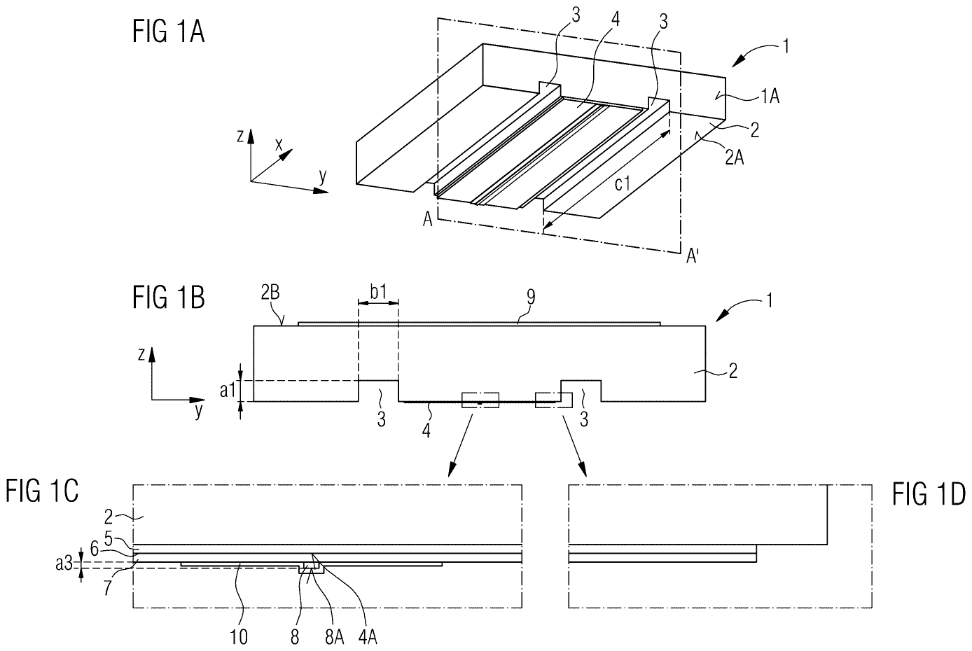

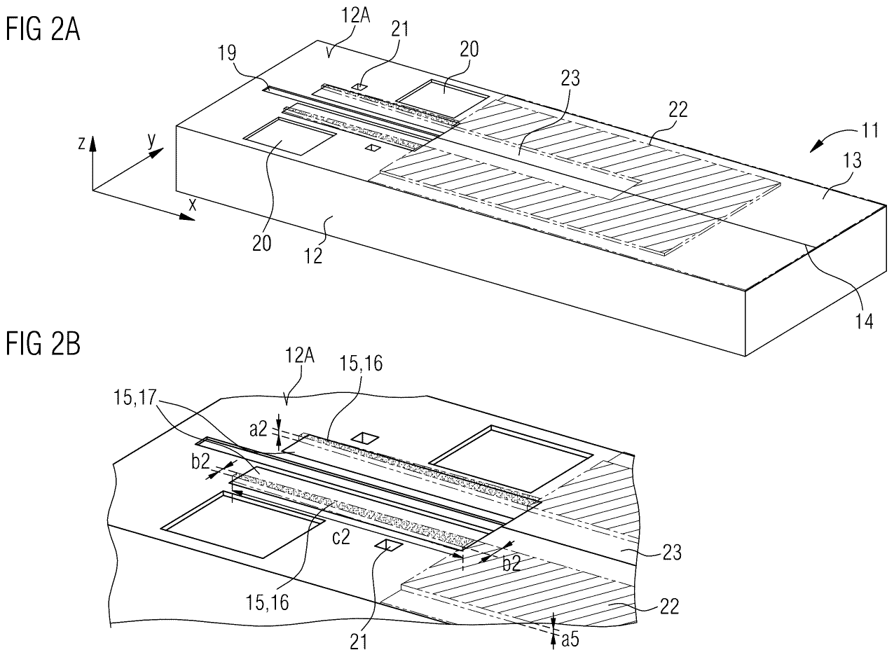

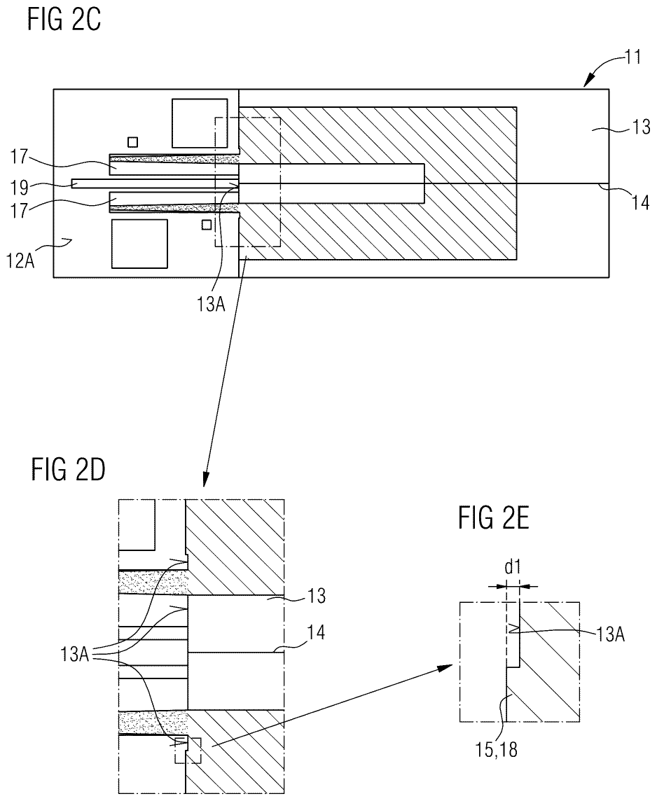

FIGS. 1A to 1D show different schematic views of an exemplary embodiment of an optoelectronic semiconductor component 1. The optoelectronic semiconductor component 1 comprises a substrate 2 with, for example, two alignment portions 3 on a mounting side 2A, wherein the alignment portions 3 have in each case a main extension along a longitudinal direction x, which means that a longitudinal extension or length c1 of the alignment portions 3 is in each case greater than at least one of the other extensions being a vertical extension a1 determined along a vertical direction z and a lateral extension or width b1 determined along a lateral direction y. The longitudinal direction x, the lateral direction y and the vertical direction z are each perpendicular to each other. The alignment portions 3 may serve for a lateral alignment of the optoelectronic semiconductor component 1 relative to another component like an optoelectronic device 11 as described in connection with FIG. 2.

The alignment portions 3 are embodied as parallel depressions, which may be etched in the substrate 2 and have a cuboid shape with a rectangular cross section perpendicular to both the lateral and the longitudinal direction y, x. Especially, the alignment portions 3 in each case have, within common production tolerances, a constant width bl and constant vertical extension a1 or depth over the entire length c1. For example, the width b1 of the alignment portions 3 in each case may have values ranging from 40 μm to 60 μm, wherein deviations of ±10% are possible. Moreover, the vertical extension a1 or depth may range in each case from 20 μm to 30 μm, wherein deviations of ±10% are possible.

Moreover, the optoelectronic semiconductor component 1 comprises a semiconductor layer stack 4 arranged on the mounting side 2A of the substrate 2 in an interspace between the alignment portions 3. For example, the semiconductor layer stack 4 is epitaxially grown on the substrate 2.

The semiconductor layer stack 4 comprises a first semiconductor region 5 of a first conductivity type, for example an n-doped semiconductor region, on a side facing the substrate 2, a second semiconductor region 7 of a second conductivity type, for example a p-doped semiconductor region, on a side facing away from the substrate 2 and an active region 6 arranged between the first semiconductor region 5 and the second semiconductor region 7, wherein the active region 6 is provided for emitting radiation.

The active region 6 may comprise a sequence of single layers which form a quantum well structure, in particular a single quantum well (SQW) structure or multiple quantum well (MQW) structure. Moreover, the first and second semiconductor regions 5, 7 may each have a sequence of single layers, some of which may be undoped or lightly doped. As mentioned above, materials based on arsenide, phosphide or nitride compound semiconductors, for example, are suitable for the semiconductor regions 5, 6, 7 or single layers of the semiconductor layer stack 4.

The optoelectronic semiconductor component 1 is embodied as a laser component, which is suitable for emitting laser radiation having a wavelength in the spectral range between ultraviolet and infrared, for example. The semiconductor layer stack 4 comprises a radiation exit surface 4A, where a major part of the radiation exits the semiconductor layer stack 4. Especially, the optoelectronic semiconductor component 1 is an edge emitting laser component and the radiation exit surface 4A is arranged at a side face 1A of the optoelectronic semiconductor component 1 perpendicularly to the longitudinal direction x.

In particular, the optoelectronic semiconductor component 1 comprises a ridge structure 8 for lateral optical confinement, wherein the ridge structure 8 extends between the alignment portions 3. The ridge structure 8 may be a part of the semiconductor layer stack 4 produced by patterning the semiconductor layer stack 4, for example by an etching process. As the etching process can stop precisely on the second semiconductor region 7, the ridge structure 8 has a reliable vertical extension a3 and thus provides for a constant vertical spacing to the radiation-emitting surface 4A with low tolerances. Therefore, a main surface 8A of the ridge structure 8 facing away from the substrate 2 may be used for a vertical alignment of the optoelectronic semiconductor component 1 relative to another component.

The optoelectronic semiconductor component 1 comprises a first contact layer 9 which is arranged on a rear side 2B of the substrate 2 facing away from the semiconductor layer stack 4 and which constitutes a first electrical terminal of the optoelectronic semiconductor component 1. Moreover, the optoelectronic semiconductor component 1 comprises a second contact layer 10 arranged at the second semiconductor region 7 and covering the ridge structure 8, wherein the second contact layer 10 constitutes a second electrical terminal of the optoelectronic semiconductor component 1.

Alternatively, it is possible that the first contact layer 9 is arranged on the mounting side 2A (not shown). As a consequence, both contact layers 9, 10 can be electrically connected in one single connection process.

In addition, the optoelectronic semiconductor component 1 may have any of the features, characteristics and advantages mentioned in connection with the further exemplary embodiments.

FIGS. 2A to 2E show different schematic views of an exemplary embodiment of an optoelectronic device 11. The optoelectronic device 11 comprises a substrate 12 including a mounting area 12A for mounting an optoelectronic semiconductor component 1 as described in connection with FIGS. 1A to 1D, for example, having alignment portions 3. For example, the substrate 12 comprises or consists of a semiconductor material like silicon. Hence, the optoelectronic device 11 may be an optoelectronic semiconductor device 11.

The optoelectronic device 11 comprises a functional unit 13, which is arranged on the substrate 12 and provides for an optical function like a waveguide function. In other words, the functional unit 13 may be a waveguide, which is provided for receiving radiation from the optoelectronic semiconductor component 1 and guiding the radiation through a core layer 14 of the waveguide along the longitudinal direction x.

The functional unit 13 embodied as a waveguide comprises layers of different refractive indices. For example, the waveguide comprises an upper and a lower cladding layer (not shown) sandwiching the core layer 14, wherein the upper and lower cladding layers have a lower refractive index than the core layer 14. Suitable materials are, for example, silicon nitride for the core layer 14 and silicon dioxide for the upper and lower cladding layers.

The functional unit 13 is arranged adjacent to the mounting area 12A. In other words, the functional unit 13 and the mounting area 12A are arranged in such a way that they do not overlap in the longitudinal direction x. Furthermore, the functional unit 13 has an end face 13A intended to face the optoelectronic semiconductor component 1, in particular the radiation exit surface 4A of the semiconductor layer stack 4. Hence, the end face 13A may be a radiation entrance surface.

Further functional units like integrated circuits or functional means like electrical connection means for electrically connecting the electrical terminals of the optoelectronic semiconductor component 1 may be arranged on or integrated in the substrate 12.

The optoelectronic device 11 comprises a positioning structure 15, which is suitable for an alignment of the optoelectronic semiconductor component 1 relative to the functional unit 13 in three spatial directions consisting of the longitudinal, lateral and vertical directions x, y, z.

The positioning structure 15 comprises for example two positioning portions 16, which are arranged at the mounting area 12A and are provided for an assembly with the alignment portions 3 of the optoelectronic semiconductor component 1. The positioning portions 16 are rod-like elements and have in each case a main extension along the longitudinal direction x. Moreover, the positioning portions 16 have a broadening shape with a width b2 determined along the lateral direction y in each case increasing over an entire length c2 towards the functional unit 13, wherein the length c2 is determined along the longitudinal direction x. For example, the width b2 of the positioning portions 16 on a side facing away from the functional unit 13 in each case may range from 10 μm to 20 μm, wherein deviations of ±10% are possible. Furthermore, on a side facing the functional unit 13, the width b2 of the positioning portions 16 may range from 40 μm to 60 μm, wherein deviations of ±10% are possible. Moreover, a vertical extension a2 or height of the positioning portions 16 protruding from the mounting area 12A determined along the vertical direction z may range in each case from 15 μm to 25 μm, wherein deviations of ±10% are possible.

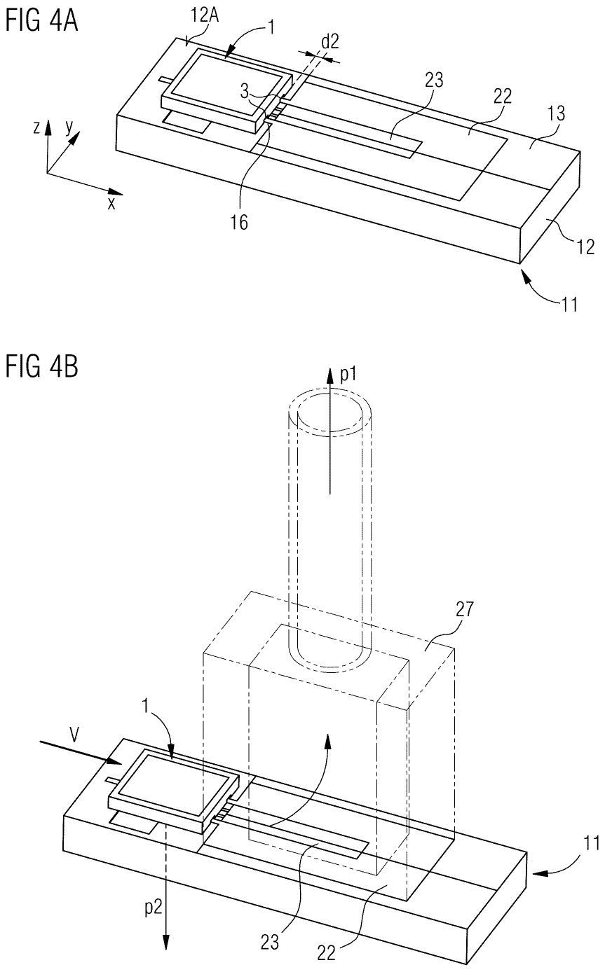

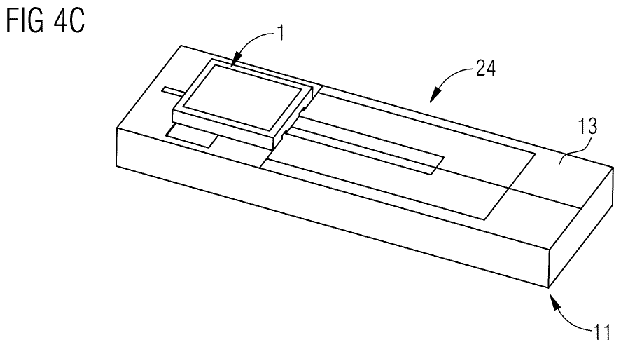

When the alignment portions 3 having a constant width b1 are inserted in the positioning portions 16 at a longitudinal distance d2 to the functional unit 13 (see FIG. 4A), the positioning portions 16 having a smaller width b2 on a side facing away from the functional unit 13 than on a side facing the functional unit 13 can provide in each case for a gap between themselves and the alignment portions 3, which becomes smaller when the distance d2 is getting smaller. This has the advantage that standard precision pick and place tools providing for high speed but having a reduced accuracy in the single to double digit micrometer range can be used for placing the optoelectronic semiconductor component 1 on the mounting area 12A. The smaller gap, however, provides for a more precise lateral alignment. This is especially advantageous in cases where the optoelectronic semiconductor component 1 embodied as an edge emitting laser, which requires a high-precision alignment of the radiation exit surface 4A relative to the radiation entrance surface 13A of the functional unit 13 embodied as a waveguide so that radiation coming from the optoelectronic semiconductor component 1 can be effectively coupled into the functional unit 13 or waveguide.

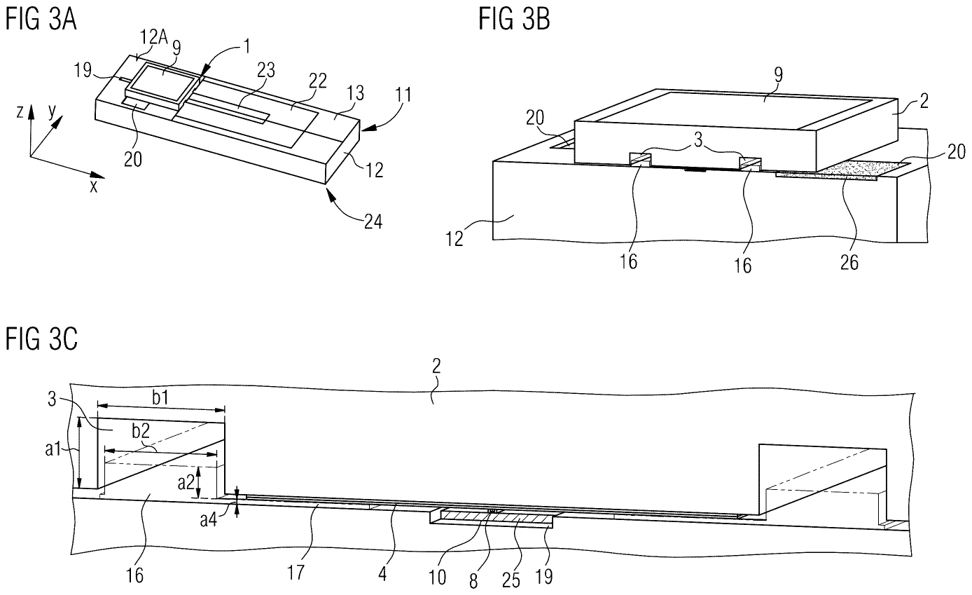

Moreover, the positioning structure 15 comprises for example two vertical adjustment regions 17 arranged at the mounting area 12A, adjacent to the positioning portions 16 along the lateral direction y, on sides of the positioning portions 16 facing each other. The vertical adjustment regions 17 are provided for a vertical adjustment of the optoelectronic semiconductor component 1 relative to the functional unit 13. As a vertical position of the radiation exit surface 4A can be precisely known due to the ridge structure 8 having a reliable vertical extension a3 (see FIG. 1), a vertical extension a4 of the vertical adjustment regions 17 (see FIG. 3C) can be adjusted in such a way that the radiation exit surface 4A is placed in the right position opposite to the end face 13A of the functional unit 13, for example in a position where the radiation is precisely coupled into the core layer 14 of the waveguide.

The vertical adjustment regions 17 are elevated regions on the mounting area 12A and have a vertical extension a4 along the vertical direction z which in each case may be at least as large as the vertical extension a3 of the ridge structure 8. The vertical extension a3 may range in each case from 1 μm to 5 μm, wherein deviations of ±10% are possible.

The vertical adjustment regions 17 are arranged in such a way that regions of the semiconductor layer stack 4 arranged between the alignment portions 3 and the ridge structure 8 are positioned on the vertical adjustment regions 17 when the optoelectronic semiconductor component 1 is mounted on the mounting area 12A.

Furthermore, the positioning structure 15 comprises projecting portions 18 projecting beyond the end face 13A of the functional unit 13 along the longitudinal direction x. For example, a longitudinal distance dl between the projecting portions 18 and the end face 13A of the functional unit 13 does not exceed a value of 5 μm, especially does not exceed a value of 1 μm, wherein deviations of ±10% are possible. The projecting portions 18 may be structured portions of the functional unit 13. The projecting portions 18 serve as mechanical stoppers providing for a longitudinal distance between the optoelectronic semiconductor component 1 and the functional unit 13. This is advantageous if the radiation exit surface 4A has a dielectric, for example an optical coating, which can be protected from damage if it does not get into contact with the end face 13A of the functional unit 13.

The positioning structure 15, that is the positioning portions 16, the vertical adjustment regions 17 and the projecting portions 18, may be formed from the same material as the upper and/or lower cladding layer(s) of the waveguide. For example, the positioning structure 15 contains or consists of silicon dioxide.

The substrate 12 comprises a cavity 19, which in a mounted stage is below the semiconductor layer stack 4 of the optoelectronic semiconductor component 1. The cavity 19 may be etched into the substrate 12. A metallized area at a bottom of the cavity 19 may serve for contacting the second contact layer 10 of the optoelectronic semiconductor component 1.

The substrate 12 comprises for example two recesses 20, which in a mounted stage are below the substrate 2 of the optoelectronic semiconductor component 1 and may comprise an adhesive material to fix the optoelectronic semiconductor component 1 on the substrate 12. The recesses 20 may be etched into the substrate 12. The recesses 20 are arranged on sides of the positioning portions 16 facing away from each other in a laterally and longitudinally offset way. This helps to fix the optoelectronic semiconductor component 1 laterally and longitudinally.

The substrate 12 comprises for example two through holes 21, which in a mounted stage are below the substrate 2 of the optoelectronic semiconductor component 1 and are arranged on sides of the positioning portions 16 facing away from each other in a laterally and longitudinally offset way. During the mounting process, a vacuum may be applied at the through holes 21 to vertically align the optoelectronic semiconductor component 1 with the optoelectronic device 11. This step helps to overcome potential frictions between the optoelectronic semiconductor component 1 and the optoelectronic device 11.

Moreover, the optoelectronic device 11 comprises a canal structure 22 on top of the functional unit 13 having a first open side facing the at least one optoelectronic semiconductor component 1 in a mounted stage and a second open side facing away from the functional unit 13. The canal structure 22 comprises a depression 23, which is accessible via the first and second open sides and is filled with air. For example, the depression 23 is surrounded by a U-shaped portion of the canal structure 22. A vertical extension a5 or height of the canal structure 22 may range from 10 μm to 20 μm, wherein deviations of ±10% are possible. The U-shaped portion may contain or consist of silicon dioxide.

In addition, the optoelectronic device 11 may have any of the features, characteristics and advantages mentioned in connection with the further exemplary embodiments.

FIGS. 3A to 3C show different schematic views of an exemplary embodiment of an optoelectronic semiconductor unit 24, which comprises at least one optoelectronic device 11 as described in connection with FIG. 2, for example, and at least one optoelectronic semiconductor component 1 as described in connection with FIG. 1, for example. The optoelectronic semiconductor unit 24 may be a photonic integrated circuit (so-called PIC) unit, wherein the optoelectronic semiconductor component 1 embodied as an edge emitting laser component and the optoelectronic device 11 comprising a functional unit 13 embodied as a waveguide constitute photonic components forming a functioning circuit.

The optoelectronic semiconductor component 1 is arranged on the mounting area 12A of the substrate 12 of the optoelectronic device 11, and the alignment portions 3 of the optoelectronic semiconductor component 1 and the positioning portions 16 of the optoelectronic device 11 engage with one another. Especially, every positioning portion 16 is inserted into and assigned to one alignment portion 3.

A width difference b1-b2 between every alignment portion 3 and its related positioning portion 16 becomes smaller in the longitudinal direction x towards the functional unit 13. While the width b2 of the positioning portions 16 may decrease more and more with increasing distance to the functional unit 13 along the longitudinal direction x, the width b1 of the related alignment portions 3 may remain constant. As mentioned above, the larger gap on a side facing away from the functional unit 13 has the advantage during mounting that standard precision pick and place tools providing for high speed may be used, while the smaller gap on a side facing the functional unit 13 provides for a higher accuracy alignment in the final position.

Moreover, a vertical distance a1-a2 between the alignment portions 3 and the positioning portions 16 may in each case be kept constant. Especially, a vertical extension a2 of every positioning portion 16 is smaller than a vertical extension al of its related alignment portion 3. The vertical distance a1-a2 provides for low surface friction between the optoelectronic semiconductor component 1 and the optoelectronic device 11 when moving the optoelectronic semiconductor component 1 to its final position on the optoelectronic device 11.

By means of the alignment and positioning portions 3, 16, the optoelectronic semiconductor component 1 is precisely laterally aligned to the functional unit 13. Moreover, by means of the vertical adjustment regions 17, the optoelectronic semiconductor component 1 is precisely vertically aligned to the functional unit 13. And by means of the projecting portions 18 (see FIG. 2E), the optoelectronic semiconductor component 1 is precisely longitudinally aligned to the functional unit 13.

The optoelectronic semiconductor component 1 is fixed in the precisely aligned position by means of an adhesive material 26 arranged in each of the recesses 20 attaching the optoelectronic semiconductor component 1 to the optoelectronic device 11. For example, the adhesive material 26 is a glue material containing or consisting of a plastic material.

The optoelectronic device 11 may provide for an electrical connection of the optoelectronic semiconductor component 1. The electrical terminals of the optoelectronic semiconductor component 1 consisting for example of the first contact layer 9 and the second contact layer 10 may be electrically connected to the optoelectronic device 11 by connection means. For example, a contact material 25 is arranged in the cavity 19 for electrically contacting the second contact layer 10. Moreover, a thermal contact may be established via the connection between the second contact layer 10 and the contact material 25.

The contact material 25 may be a sintered material. Compared to a fluid solder material, the risk of contamination of the semiconductor layer stack 4 is lower with the sintered material.

In addition, the optoelectronic semiconductor unit 24 may have any of the features, characteristics and advantages mentioned in connection with the further exemplary embodiments.

FIGS. 4A to 4c illustrate different steps of an exemplary embodiment of a method for producing an optoelectronic semiconductor unit 24 as described in connection with FIG. 3, for example.

As becomes evident from FIG. 4A, the method comprises providing an optoelectronic device 11 for example of the kind as described in connection with FIG. 2 and providing an optoelectronic semiconductor component 1 for example of the kind as described in connection with FIG. 1.

Moreover, the method comprises placing the optoelectronic semiconductor component 1 on the mounting area 12A of the substrate 12 of the optoelectronic device 11 at a distance d2 to the functional unit 13 in the longitudinal direction x in such a way that the alignment portions 3 and positioning portions 16 engage with each other.

For example, a pick and place tool puts the optoelectronic semiconductor component 1 at a predefined, initial position on the optoelectronic device 11 where the width b2 of the positioning portions 16 is smaller than the width b1 of the alignment portions 3 (see FIGS. 1B and 2B). This ensures the catch-up of the positioning portions 16 and alignment portions 3 with the limited precision of a passive pick and place tool.

As becomes evident from FIG. 4B, the method further comprises moving (see arrow v) the optoelectronic semiconductor component 1 towards the functional unit 13 to a final position by decreasing the distance d2. The movement arises by reducing an air pressure in a gap existing between the optoelectronic semiconductor component 1 and the functional unit 13 at a distance d2 larger than zero. In other words, a low pressure zone is generated in the gap, which results in the normal air pressure pushing the optoelectronic semiconductor component 1 towards the functional unit 13. The air pressure in the gap can be reduced by a vacuum nozzle 27, which is arranged on the canal structure 22 and provides for suction of air out of the gap via the first open side and the second open side of the depression 23 (see arrow p1). In comparison to processes which use capillary or surface tension forces, this method provides for positioning of the optoelectronic semiconductor component 1 with much higher reliability.

During the movement, the positioning portions 16 serve as guide bars where the optoelectronic semiconductor component 1 glides along to its final position. The optoelectronic semiconductor component 1 is stopped by the projecting portions 18 (see FIG. 2E) at its final position, wherein the radiation exit surface 4A of the semiconductor layer stack 4 may be flush with the projecting portions 18 so that the radiation exit surface 4A has the distance d1 (see FIG. 2E) to the end face 13A of the functional unit 13.

In the final position (see FIG. 4C), a width difference b1-b2 between every positioning portion 16 and its related alignment portion 3 becomes smaller in the longitudinal direction x towards the functional unit 13 and will be smallest, for example about zero, at a position closest to the functional unit 13.

The method may further comprise reducing the air pressure under the optoelectronic semiconductor component 1 by air suction via the through holes 21 (see arrow p2 and FIGS. 2A and 2B). This step helps to overcome potential frictions between the optoelectronic semiconductor component 1 and the optoelectronic device 11. The semiconductor layer stack 4 is thus forced to align with a well-defined level on the vertical adjustment regions 17 (see FIG. 2B), which vertically sets the optoelectronic semiconductor component 1 precisely relative to the functional unit 13. During the movement of the optoelectronic semiconductor component 1, however, the air pressure may be increased at the through holes 21, which helps to overcome potential frictions between the optoelectronic semiconductor component 1 and the vertical adjustment regions 17 of the optoelectronic device 11.

The alignment portions 3 and positioning portions 16 engaging with each other as well as the vertical alignment regions 17 and the projecting portions 18 allow for a passive alignment of the optoelectronic device 11 and the optoelectronic semiconductor component 1 with high accuracy.

Before placing the optoelectronic semiconductor component 1 on the mounting area 12A, the adhesive material 26 may be dispensed in the recesses 20 (see FIG. 3B) and the contact material 25 may be dispensed in the cavity 19 (see FIG. 3C). After the optoelectronic semiconductor component 1 has reached its final position, the adhesive material 26 can be cured, for example by applying UV radiation and without releasing air suction. This will fix the optoelectronic semiconductor component 1 in the intended final position. Afterwards, air suction can be released. Then, the contact material 25 can be thermally cured or sintered.

The method may be conducted with a plurality of optoelectronic semiconductor components 1 and a plurality of optoelectronic devices 11. The plurality of optoelectronic semiconductor components 1 may be provided as a composite with a common substrate 2 and a plurality of semiconductor layer stacks 4 provided thereon. For example, the plurality of optoelectronic semiconductor components 1 may be provided as at least one laser bar. Moreover, the plurality of optoelectronic devices 11 may be provided as a composite, wherein at least the substrate 12 is a common element.

The whole process can be carried out at wafer level with no need for an active alignment process, which renders the whole process particularly efficient.

In addition, the method may have any of the features, characteristics and advantages mentioned in connection with the further exemplary embodiments.

The scope of protection of the invention is not limited to the examples given hereinabove. The invention is embodied in each novel characteristic and each combination of characteristics, which particularly includes every combination of any features which are stated in the claims, even if this feature or this combination of features is not explicitly stated in the claims or in the examples.

1. An optoelectronic semiconductor unit comprising:
at least one optoelectronic device comprising,
a substrate comprising a mounting area,
a functional unit, which provides for an optical function, is arranged at least partly adjacent to the mounting area and has an end face intended to face an optoelectronic semiconductor component, and
a positioning structure comprising positioning portions, which are arranged at the mounting area, wherein the positioning portions have in each case a main extension along a longitudinal direction, and wherein a width of the positioning portions determined along a lateral direction perpendicular to the longitudinal direction in each case increases along the longitudinal direction towards the functional unit, and
at least one optoelectronic semiconductor component comprising,
a substrate comprising alignment portions on a mounting side, wherein the alignment portions (3) have in each case a main extension along the longitudinal direction, and
a semiconductor layer stack, which is arranged on the mounting side of the substrate in an interspace between the alignment portions,
wherein:
the optoelectronic semiconductor component is arranged on the mounting area of the substrate of the optoelectronic device, and the alignment portions and positioning portions engage with one another, wherein a width difference between every positioning portion and its related alignment portion becomes smaller in the longitudinal direction towards the functional unit, and
the positioning structure comprises vertical adjustment regions arranged at the mounting area and adjacent to the positioning portions, wherein the vertical adjustment regions are provided for a vertical adjustment of the optoelectronic semiconductor component relative to the functional unit.

2. The optoelectronic semiconductor unit according to claim 1, wherein a width of the alignment portions determined along a lateral direction perpendicular to the longitudinal direction in each case is constant within common production tolerances.

3. The optoelectronic semiconductor unit according to claim 1, wherein the alignment portions are depressions of the substrate.

4. The optoelectronic semiconductor unit according to claim 1, wherein the semiconductor layer stack comprises a first semiconductor region of a first conductivity type on a side facing the substrate, a second semiconductor region of a second conductivity type on a side facing away from the substrate and an active region arranged between the first semiconductor region and the second semiconductor region, wherein the active region is provided for emitting radiation.

5. The optoelectronic semiconductor unit according to claim 1, wherein the at least one optoelectronic semiconductor component is an edge emitting laser component and the semiconductor layer stack comprises a radiation exit surface at a side face of the optoelectronic semiconductor component.

6. The optoelectronic semiconductor unit according to claim 5, wherein the at least one optoelectronic semiconductor component comprises a ridge structure, and the ridge structure extends between the alignment portions.

7. The optoelectronic semiconductor unit according to claim 1, wherein the positioning structure comprises projecting portions projecting beyond the end face of the functional unit.

8. The optoelectronic semiconductor unit according to claim 1, wherein the functional unit is a waveguide.

9. The optoelectronic semiconductor unit according to claim 1, wherein the positioning portions are rod-like elements protruding from the mounting area.

10. The optoelectronic semiconductor unit according to claim 1, wherein the width of the positioning portions decreases more and more compared to the width of the related alignment portions with increasing distance to the functional unit in the longitudinal direction.

11. The optoelectronic semiconductor unit according to claim 1, wherein a vertical extension of every positioning portion is smaller than a vertical extension of its related alignment portion.

12. The optoelectronic semiconductor unit according to claim 1, wherein the substrate of the optoelectronic device comprises a cavity below the semiconductor layer stack, wherein a contact material is arranged in the cavity for electrically and/or thermally contacting the semiconductor layer stack.

13. The optoelectronic semiconductor unit according to claim 12, wherein the contact material is a sintered material.

14. The optoelectronic semiconductor unit according to claim 1, wherein the substrate of the optoelectronic device comprises at least one recess below the substrate of the optoelectronic semiconductor component, wherein an adhesive material is arranged in the at least one recess, attaching the optoelectronic semiconductor component to the optoelectronic device.

15. The optoelectronic semiconductor unit according to claim 1, wherein vertical distances between the alignment portions and the positioning portions are in each case greater than zero.

16. A method for producing an optoelectronic semiconductor unit according to claim 1, the method comprising:
providing at least one optoelectronic device comprising,
a substrate comprising a mounting area,
a functional unit, which provides for an optical function, is arranged at least partly adjacent to the mounting area and has an end face intended to face an optoelectronic semiconductor component, and
a positioning structure comprising positioning portions, which are arranged at the mounting area, wherein the positioning portions have in each case a main extension along a longitudinal direction, and wherein a width of the positioning portions determined along a lateral direction perpendicular to the longitudinal direction in each case increases along the longitudinal direction towards the functional unit,
providing at least one optoelectronic semiconductor component comprising,
a substrate comprising alignment portions on a mounting side, wherein the alignment portions have in each case a main extension along the longitudinal direction, and
a semiconductor layer stack, which is arranged on the mounting side of the substrate in an interspace between the alignment portions,
placing the at least one optoelectronic semiconductor component on the mounting area of the substrate of the at least one optoelectronic device at a distance to the functional unit in the longitudinal direction in such a way that the alignment portions and positioning portions engage with each other, and
moving the at least one optoelectronic semiconductor component towards the functional unit to a final position by decreasing the distance, wherein:
at the final position a width difference between every positioning portion and its related alignment portion becomes smaller in the longitudinal direction towards the functional unit, and
the positioning structure comprises vertical adjustment regions arranged at the mounting area and adjacent to the positioning portions, wherein the vertical adjustment regions are provided for a vertical adjustment of the optoelectronic semiconductor component relative to the functional unit.

17. The method according to claim 16, wherein the at least one optoelectronic semiconductor component is moved by reducing an air pressure in a gap between the optoelectronic semiconductor component and the functional unit, wherein
the optoelectronic device is provided with a canal structure on top of the functional unit, wherein the canal structure has a first open side facing the at least one optoelectronic semiconductor component and a second open side facing away from the functional unit, and
the air pressure is reduced by air suction at the second open side.

18. The method according to claim 16, wherein
the substrate of the optoelectronic device is provided with at least one through hole below the substrate of the optoelectronic semiconductor component, and
an air pressure is reduced by air suction at the at least one through hole to vertically align the optoelectronic semiconductor component with the optoelectronic device.
